(19) United States
(12) Patent Application Publication
(10) Pub. No.: US 2008/0179874 A1
(43) Pub. Date: Jul. 31, 2008

(54) Personal recording page and document marker

(76) Inventors: Meryl Zegarek, New York, NY (US); Sandy Damashek, New York, NY (US); Greg Hyman, Boca Raton, FL (US)

Correspondence Address: M. LUKACHER, 70 A BERTHAW RD., ROCHESTER, NY, 14610, US

(21) Appl. No.: 12/012,188

(22) Filed: Jan. 31, 2008

Related U.S. Application Data
(60) Provisional application No. 60/898,259, filed on Jan. 31, 2007.

(51) Int. Cl. B42D 9/00; H04R 3/00

(52) U.S. Cl. 281/42; 381/122

(57) ABSTRACT

A personal recording page and document marker is provided by an audio-electronic module having a housing. A spring clip on the housing is adopted to attach the module to the cover of a book, report, or document. The module contains a recording/playback unit connected to a microphone/speaker exposed on a face of the housing. The recording/playback unit is activated by record and play buttons recessed in a face of the housing which operate switches connected to the recording and playback unit. A battery pack or compartment holds batteries which power the recording/playback unit.

### FIELD OF THE INVENTION

The present invention relates to a personal recording page and document marker which contains a record/playback unit attachable to a book, page in a book, report or document with a spring clip. The personal recording page and document marker is identified by a trademark “Voice Clip.”

### BACKGROUND AND SUMMARY OF THE INVENTION

Don't you hate when this happens? You open your book to return to that exciting part where you left off, and your bookmark falls to the floor OR is it just plain missing? Now, what page were you on? Where were you in that exciting story? If you had VOICE CLIP, you would know instantly.

VOICE CLIP clips on to any book cover or thin surface and gives you 8 seconds or more of recording time. When you decide to put your book down, you can record and save the date, page number or add a special note about where you left off in the story. No need to backtrack, wander through paragraphs, or re-read pages.

When you have finished reading, simply press and hold RECORD. Then say the last page number that you've read and add any note or reminder you like. Your page number and note will be saved for 99 years. You should be able to finish the book by then . . . The next time you come back to the book, press PLAY and VOICE CLIP will play back your recording, reminding you what page you were on and where you last were in the story. You will never lose your place again!

But, VOICE CLIP is much more than a bookmark; it can be a business tool too. Just clip VOICE CLIP onto a report or document that you're sending to a colleague or client and record a spoken note. It's the perfect way to add a personal touch, in your own voice. VOICE CLIP lets you “Say It and Save It.”

Accordingly, the principal object of the invention is to provide an electronic bookmark. Another object of the invention is to provide an electronic bookmark which records and may note the date, page numbers and brief identifying messages.

Another object of the invention is to provide a bookmark which is personally controlled by the reader of the book and is removably attachable to the book, report or document. The foregoing objects, features and advantages of the invention will become more apparent from a reading of the following description taken with the accompanying drawings:

### BRIEF DESCRIPTION OF DRAWINGS

FIG. 1 is a view from the front of an electronic personal page and document marker is accordance with the invention;

FIG. 2 is a view from the rear of the page and document marker shown in FIG. 1; and

FIG. 3 is a schematic diagram of the page and document marker shown in FIG. 1.

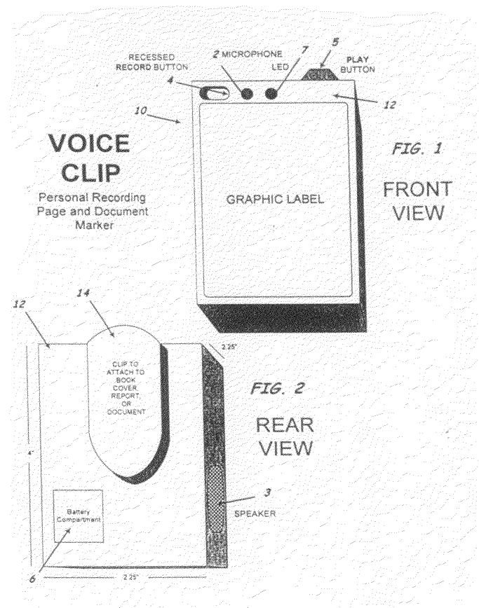

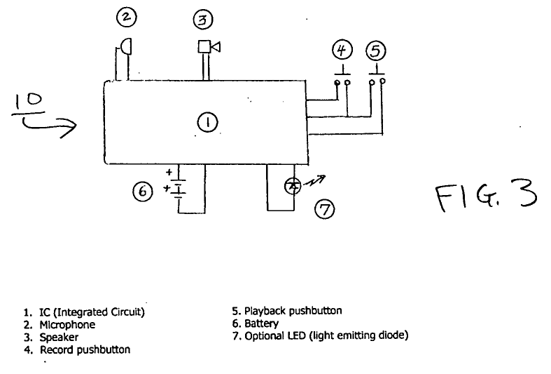

### DETAILED DESCRIPTION

Referring to the drawings:

The drawings show a preferred embodiment of the invention, the Voice Clip (10), which is an audio-electronic module protected by a housing (12), that may be fastened to a book or document with a spring clip (14). A typical size for the module may be, for example, 4″×2.25″×1″. A microphone (2), speaker (3), PLAYBACK and RECORD buttons (4 and 5) are located on the faces of the housing (12). The RECORD button (4) is recessed to prevent accidental recording over a previous recording.

Recording of a message takes place as the RECORD button (4) is depressed and held down while the user speaks into the microphone (2). The user releases the RECORD button to stop recording. Recordings may be 8 seconds or more in duration depending on the IC used. If an individual records in excess of 8 seconds, a “beep” plays to indicate that the 8-second memory is full and recording is complete. A new recording erases the previous recording. An LED (7) may also illuminate to indicate record mode and may extinguish when recording is complete.

Playback of a message occurs when the PLAYBACK button is momentarily pressed. The Item is powered by a replaceable battery power supply (6). The Item turns ON when the RECORD or PLAYBACK button is pressed and turns itself OFF when PLAYBACK or RECORDING has ceased.

The electronic module (1) internal to the item includes a RECORD/PLAYBACK Integrated Circuit (IC). In a preferred embodiment of the invention, the IC is of the type that directly records the audio (analog) input signal. A preferred IC is model ISD 4004 made by Information Storage Devices of San Jose, Calif. This IC has a non-volatile memory that can retain stored information for as long as 99 years without the need for external power and has a memory for storing a predetermined duration audio message directly in analog form. The length of recording time may be extended beyond 8 seconds by selecting a different IC.

1- a personal page and document marker comprising a housing exposing controls, and a speaker/microphone, said housing containing an electronic circuit for carrying out recording of input from said microphone and playback of the recording from the speaker, and a clip on the housing for attachment of the page marker to the cover of a book, a report, or a document.

2- The page marker per claim 1 further comprising a graphic receiving sheet on a face of said housing.

3- The page marker per claim 1 where said clip is a spring clip hinged at one end to said housing near an edge thereof and disposable in clamping relationship with the cover, report or document.
